(19) United States
(12) Patent Application Publication
(10) Pub. No.: US 2005/0141873 A1
(43) Pub. Date: Jun. 30, 2005

(54) Recording/reproduction apparatus

(75) Inventor: Tomoyuki Shimaya, Fuchu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/019,818

(22) Filed: Dec. 23, 2004

(30) Foreign Application Priority Data
Dec. 25, 2003 (JP) 2003-430601

(51) Int. Cl. H04N 5/76; G06F 3/00; G06F 13/00

(52) U.S. Cl. 386/83; 725/58

(57) ABSTRACT

A reservation information table stores reservation information including a channel number, a recording start time, a recording end time, and an attribute related to each recording-reserved program. A group information table stores group information including a total capacity setting value for each group. An MPU selectively deletes a recorded program from recorded programs belonging to the same group when the total data amount of the recorded programs belonging to the group exceeds the corresponding total capacity setting value.

### CROSS-REFERENCE TO RELATED APPLICATIONS

This application is based upon and claims the benefit of priority from prior Japanese Patent Application No. 2003-430601, filed Dec. 25, 2003, the entire contents of which are incorporated herein by reference.

### BACKGROUND OF THE INVENTION

1. Field of the Invention

The present invention relates to an apparatus that records/reproduces video information, and more particularly, to a recording/reproduction apparatus capable of ensuring remaining recording capacity.

2. Description of the Related Art

In a video recording apparatus that records information including video information, audio information, control information and the like onto a recording medium and reproduces the above information from the recording medium, video-recording reservation information such as recording start date and time/recording end date and time, a title of content (program) to be recorded, and record rate is set through an apparatus main body or associated remote control device and thereby the specified (set) content is recorded on the specified date and time, at the specified record rate.

Recently, it is possible to specify recording sources such as recording (broadcasting) start date and time/recording (broadcasting) end date and time, and channel of content (program) to be recorded by inputting only a recording reservation code called “G-code” to a recording/reproduction apparatus through an input device such as a remote control device. This can reduce an amount of the video-recording reservation information to be input to a recording/reproduction apparatus at the time when the video-recording reservation is made.

When a recording operation is repeated without deleting recorded programs in the video recording/reproduction apparatus described above, remaining recording capacity (available space) in a recording medium is reduced, as a matter of course, and finally the recording operation will be disabled. A technique of automatically deleting recorded program is disclosed in Jpn. Pat. Appln. KOKAI Publication No. 2002-335476.

In the above patent document, the program that is periodically broadcasted is overwritten. On the other hand, the program that is not periodically broadcasted is not overwritten (deleted). Therefore, the remaining space of a recording medium is reduced every time a recording operation is made, and finally the recording operation will be disabled.

### BRIEF SUMMARY OF THE INVENTION

A recording/reproduction apparatus according to an embodiment of the present invention comprises: a storage unit that stores reservation information including a channel number, a recording start time, a recording end time, and an attribute related to each recording-reserved program; another storage unit that stores attribute information including a total capacity setting value related to each attribute; a record unit that records a recording-reserved program together with the attribute based on the reservation information; and a deletion unit that performs a selective deletion operation in such a manner that when the total data amount of recorded programs having the same attribute exceeds the corresponding total capacity setting value, the deletion unit deletes a program from the recorded programs that have been recorded by the record unit and have the relevant attribute.

As a result, it is possible to provide a recording/reproduction apparatus capable of preventing the problem of running out of free space in a recording medium from occurring by imposing some recording restrictions on various kinds of programs.

Additional advantages of the invention will be set forth in the description which follows, and in part will be obvious from the description, or may be learned by practice of the invention. The advantages of the invention may be realized and obtained by means of the instrumentalities and combinations particularly pointed out herein after.

### BRIEF DESCRIPTION OF SEVERAL VIEWS OF THE DRAWINGS

The accompanying drawings, which are incorporated in and constitute a part of the specification, illustrate embodiments of the invention and, together with the general description given above and the detailed description of the embodiments given below, serve to explain the principles of the invention.

FIG. 1 is a block diagram showing a configuration of a video recording apparatus 1 according to an embodiment of the present invention;

FIG. 2 is a view schematically showing configurations of a reservation information table and group information table according to the embodiment of the present invention;

FIG. 3A is a view showing a capacity setting form for each group;

FIG. 3B is a view showing another capacity setting form for each group;

FIG. 4 is a view showing a concept of a method for deleting a program when the data amount of recorded programs has exceeded a capacity setting value in each group;

FIG. 5 is a view showing details of a reservation information table 10;

FIG. 6 is a view showing details of a group information table 20;

FIG. 7 is a view showing an example of a reservation information setting window;

FIG. 8 is a flowchart showing an operation at the recording reservation time;

FIG. 9 is a flowchart showing details of selective deletion operation performed by an MPU 105;

FIG. 10 is a flowchart showing details of selective deletion operation performed by the MPU 105;

FIG. 11 is a view showing an example of a result obtained by sorting programs;

FIG. 12 is a flowchart showing an operation at the time when a reserved recording is performed;

FIG. 13 is a flowchart showing a program deletion operation at the time when a reserved recording is performed;

FIG. 14 is a flowchart showing an operation according to a third embodiment;

FIG. 15 is a reservation information table according to the third embodiment;

FIG. 16 is a group information table according to the third embodiment;

FIG. 17 is a flowchart showing a selective deletion operation for recorded programs according to the third embodiment;

FIG. 18 is a flowchart showing an operation according to a fourth embodiment;

FIG. 19 is a flowchart showing a modification of the fourth embodiment; and

FIG. 20 is a flowchart showing an operation according to a fifth embodiment.

### DETAILED DESCRIPTION OF THE INVENTION

Embodiments of the present invention will be described below in detail with reference to the accompanying drawings.

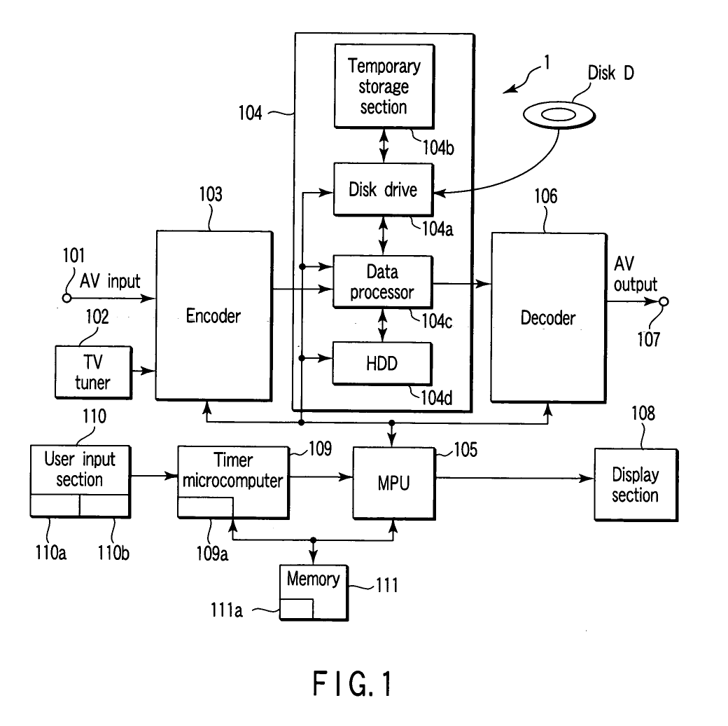

FIG. 1 is a block diagram showing a configuration of a video recording apparatus 1 according to an embodiment of the present invention. The video recording apparatus 1 includes a recording/reproduction section 104 that records input video information onto a predetermined recording medium and reproduces the recorded video information in response to a reproduction instruction, and a microcomputer (MPU, or main control unit) 105 that controls recording/reproduction operation to or from the recording/reproduction section 104 and operation of each component to be described below.

The recording/reproduction section 104 includes: a disk drive 104a which can record or reproduce information onto or from a disk D manufactured according to, for example, a DVD (Digital Versatile Disk) standard; a temporary storage section 104b functioning as a buffering memory capable of temporarily holding a certain amount of the data to be recorded onto the disk D set in the disk drive unit 104a or the data reproduced from the disk D; an HDD 104d that can record large volume of data; and a data processor 104c.

Under control of the MPU 105, the data processor 104c supplies the disk drive 104a with recording data output from an encoder 103 or inputs a reproduction signal of the disk D through the disk drive 104a so as to supply a decoder 106 with the reproduction signal. Further, under control of the MPU 105, the data processor 104c supplies the HDD 104d with recording data output from the encoder 103 or supplies the decoder 106 with a reproduction signal from the HDD 104d. Further, under control of the MPU 105, the data processor 104c rewrites management information recoded on the disk D or the HDD 104d, or deletes recorded data.

The temporary storage section 104b can temporarily store the information to be recorded and can be used, in particular, at the time since the recording capacity of the disk D had been used up in the middle of the recording operation until the disk D has been replaced by another disk having enough recording capacity. Here, the disk D is assumed to be a recordable optical disk such as a write-once DVD-R or rewritable DVD-RAM.

The encoder 103 encodes/compresses an input video signal. Connected to the encoder 103 are an AV input terminal 101 for inputting an video signal to be recorded from an external device and a tuner 102 that can receive video and audio data distributed from information providers represented by, for example, a broadcasting provider.

The decoder 106 decodes and expands video information output from the recording/reproduction section 104. Connected to the decoder 106 is an AV output terminal 107 for supplying a reproduction apparatus such as a TV set with the decoded (by decoder 106) reproduction information.

A timer microcomputer 109, which is connected to the MPU 105, has a timer circuit (clock unit) 109a used in time management of the video recording apparatus 1. Connected to the timer microcomputer 109 is a user input section 110 for receiving an operation (instruction) from a user.

Further connected to the MPU 105 are the user input section 111 and a memory 111 that can hold recording reservation information and the like.

According to a control program stored in the memory 111, the MPU 105 controls recording, reproduction, and deletion operations of information onto or from the disk D, a recording operation associated with recording reservation information input through the user input section 110, a display operation using a display section 108, and the like.

The timer microcomputer 109 monitors the timer circuit (clock unit) 109a and a recording reservation information table 111a to manage recording reservation information. The timer microcomputer 109 outputs a record start instruction to the MPU 105 at the reserved recording start time and outputs a record end instruction to the MPU 105 at the reserved recording end time.

Through the user input section 110, a user allows the recording apparatus to perform recording or reproduction operation, and can input recording reservation information and change the recording reservation information. The user input section 110 includes a data reception section 110b for receiving a control signal transmitted from a not-shown remote control device (remote control terminal), an operation panel 110a that can directly receive a user's instruction and output a control signal to the timer microcomputer 109.

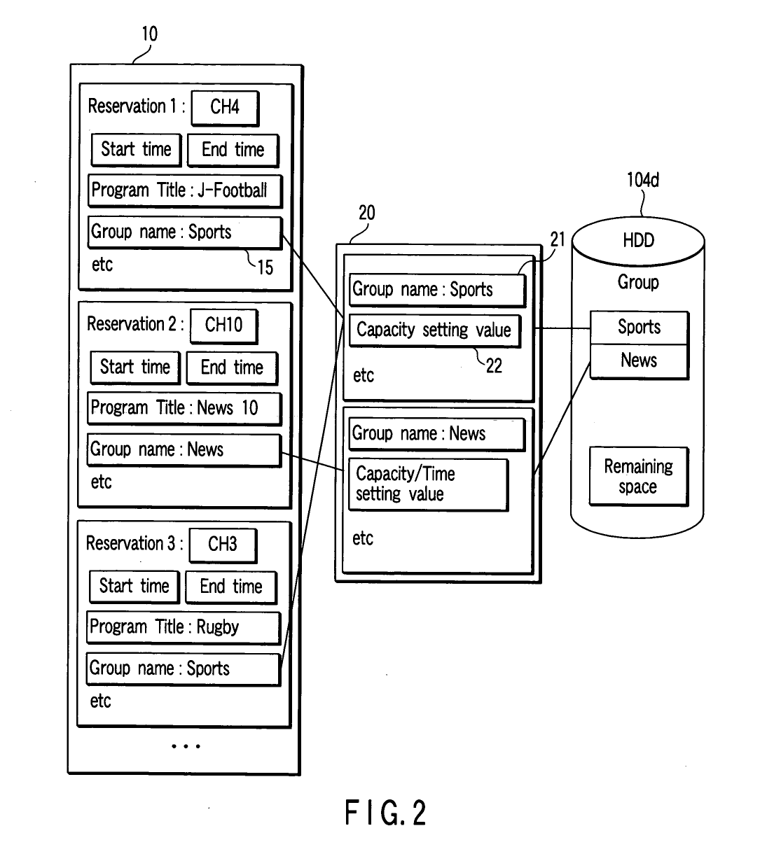

FIG. 2 is a view schematically showing configurations of the reservation information table and group information table according to the present invention. When a recording operation is repeated in a conventional video recording/reproduction apparatus, remaining recording capacity (available space) in a recording section such as an HDD is reduced, and finally the recording operation will be disabled. In order to cope with this problem, in the present embodiment, an attribute (group name) is set to a program to be recorded, and a storage period or recording capacity is separately set for each group. In the above configuration, recording is performed with overwriting operation repeated within the set recording capacity and/or storage period.

As shown in FIG. 2, the reservation information table 10 is constituted by reservation information that a user sets using a remote control device or the like. The reservation information table 10 can include general reservation information such as a channel number of the program to be recorded or recording start time, as well as a group name 15 according to the present embodiment. Group information table 20 includes a capacity (reproduction time) setting value 22 of the HDD 104d assigned to each group.

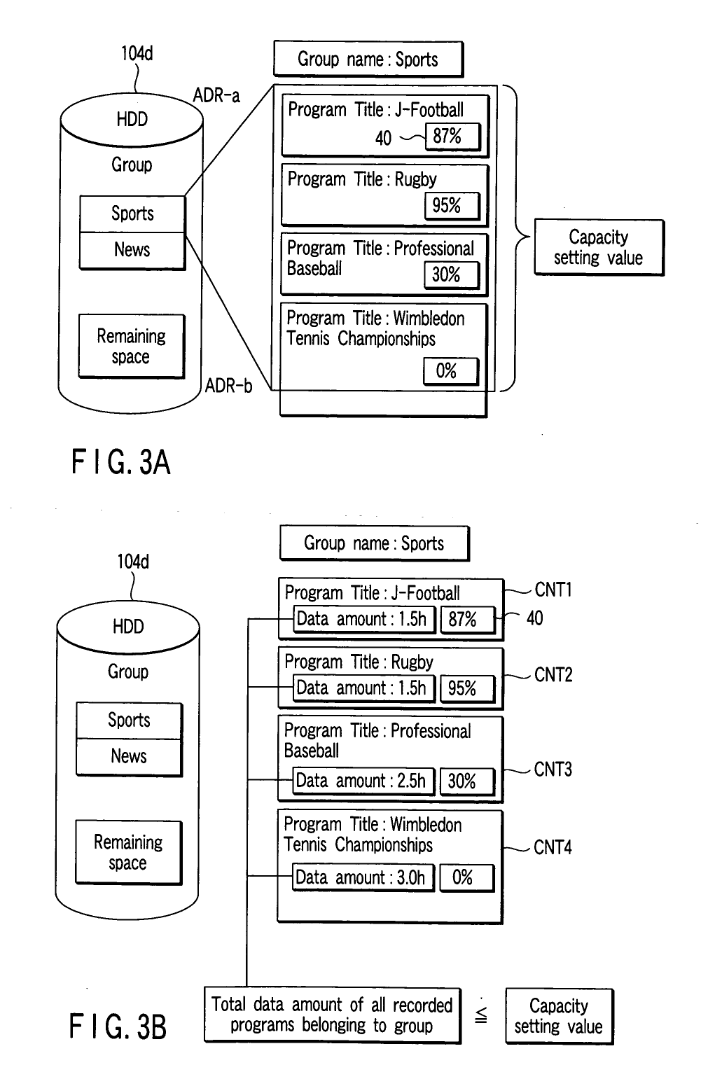

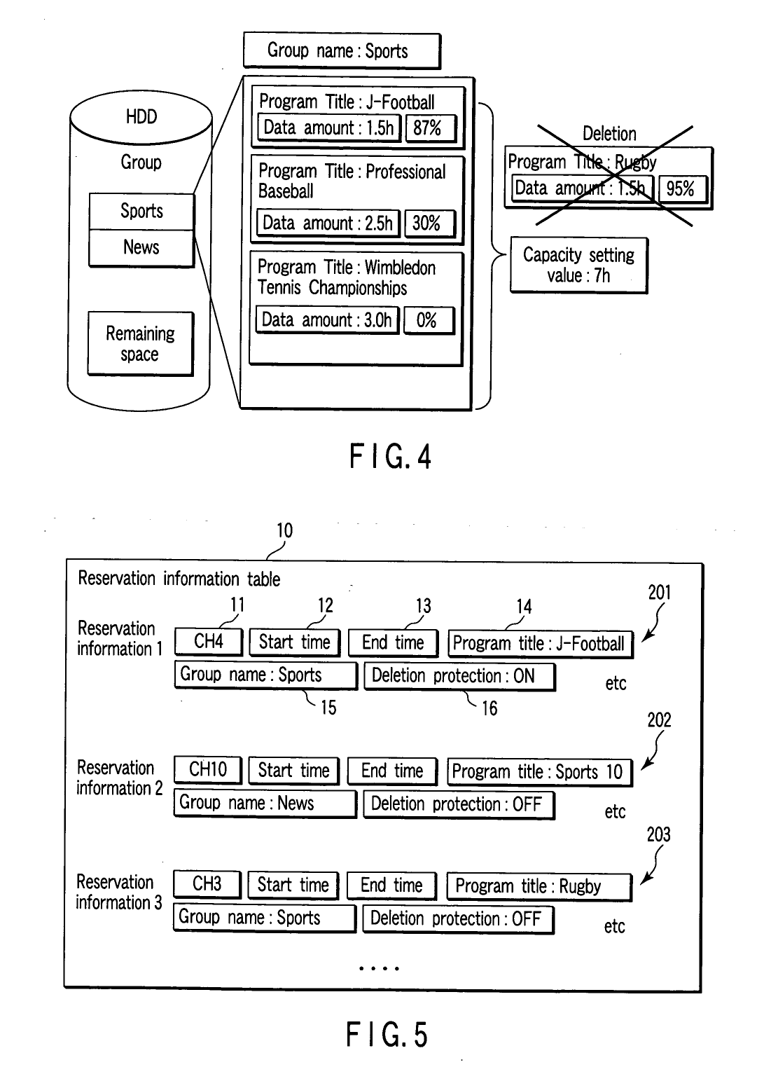

FIGS. 3A and 3B are views showing a capacity setting form for each group, and FIG. 4 is a view showing a concept of a method for deleting a program when the data amount of recorded programs has exceeded a capacity setting value.

In the case of FIG. 3A, storage areas in the HDD 104d are provided for each group. That is, address area (ADR-a to ADR-b) of HDD 104d are set in correspondence with the capacity that has been set for each group. Reference numeral 40 denotes a reproduction ratio (viewed (reproduced) part to the whole) of a program, which is to be described later. On the other hand, in the case of FIG. 3B, address areas in the HDD 104d are not provided but a total capacity is set for the programs belonging to each group. Either form may be adopted, as needed.

It is assumed that, as shown in FIG. 3B, programs CNT 1 to CNT 3 are recorded as “sports” group, and a program CNT 4 is recorded at the last and thereby a total data amount of the recorded program has exceeded the allocated capacity for the group. In this case, as shown in FIG. 4, the program with the longest storage period or the program with the highest reproduction ratio 40 among the programs that have already been viewed by a user is preferentially deleted.

As a pattern in which a recorded program is deleted, the following four patterns can be set in the present embodiment:
1. selectively delete a program from recorded programs in the group whose total data amount has exceeded the set capacity at the completion time of a recording operation.
2. selectively delete a program from recorded programs in the group whose total data amount has exceeded the set capacity before the start of the next recording operation.
3. selectively delete a program from recorded programs in the group whose total data amount plus a data amount of the program to be recorded from now has exceeded the set capacity before the start of the next recording operation.
4. combination of the above 1 and 2.

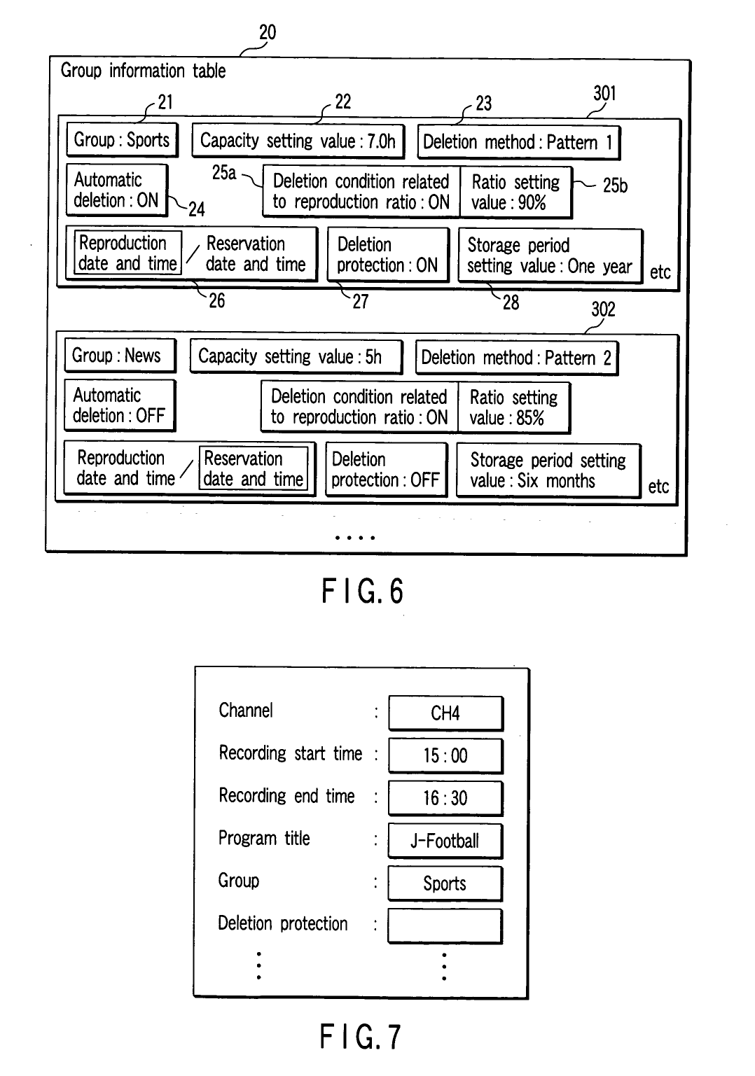

FIG. 5 is a view showing details of the reservation information table 10, and FIG. 6 is a view showing details of the group information table 20.

As shown in FIG. 5, reservation information 201, 202, 203 . . . , corresponding to recording-reserved programs are registered in the reservation information table 10. Each of the registered recording information includes reservation information items such as a channel number 11, a recording start time 12, a recording end time 13, a program title 14, a group name 15, and a deletion protection 16. The reservation information 201, 202, 203 . . . , is recorded onto an HDD together with video information of the recording-reserved program when the video information is recorded onto the HDD. Therefore, reservation information corresponding to the recorded program can be checked using the HDD.

The group name 15, which is an attribute of each of recording-reserved programs, can be set like this: “Group name: Sports”. The deletion protection 16 is an item indicating availability of the deletion operation automatically performed according to deletion condition (to be described later) with respect to the corresponding recording-reserved program.

As shown in FIG. 6, each of the group information 301, 302, . . . , to be registered in the group information table 20 includes attribute information such as a group name 21, a capacity (reproduction time) setting value 22, a deletion method 23, an automatic deletion 24, a deletion condition 25a related to reproduction ratio, a ratio setting value 25b, a reproduction date and time/reservation date and time 26, a deletion protection 27, and a storage period setting value 28. As described above, the attribute information is registered in the group information table 20.

The group name 21 is identification information for identifying each group information. The capacity setting value 22 is a value indicating the recording capacity allocated to each group by reproduction time (broadcasting time). When a program is compressed according to, for example, an MPEG-2 scheme and recorded, the recording capacity to be used changes depending on compression rate used at that time. In this case, the recording capacity to be used in the recording of the program is represented by the time length during which the program has been broadcasted, that is, the reproduction time of the recorded program. Further, the value can represent capacity itself (unit: Byte) instead of time. As the deletion method 23, one of the above four deletion pattern can be set. The automatic deletion 24 is an item for setting availability of the deletion operation automatically performed according to deletion condition (to be described later) in the case where the capacity setting value 22 has been exceeded by the data amount of the recorded program. The reproduction date and time/reservation date and time 26 is an item for determining whether “oldness” of the recorded program is calculated on the basis of the date and time on which the program has been reproduced or on which the reserved-recording of the program has been performed. The deletion protection 27 is an item for preventing (forbidding) deletion operation for all recorded programs belonging to the corresponding group. The storage period setting value 28 is an item for restricting the storage period of the recorded program for each group. The above items are set by a user through user input section 110.

FIG. 7 is a view showing an example of a reservation information setting window. When a recording reservation of a program is performed, the reservation information setting window as shown in FIG. 7 is displayed, for example, on the monitor screen of a television set. On the reservation information setting window, information including the reservation information items 11 to 16 shown in FIG. 5 is displayed. A user performs a recording reservation operation through the user input section 110 (or remote control device) while checking the reservation information setting window.

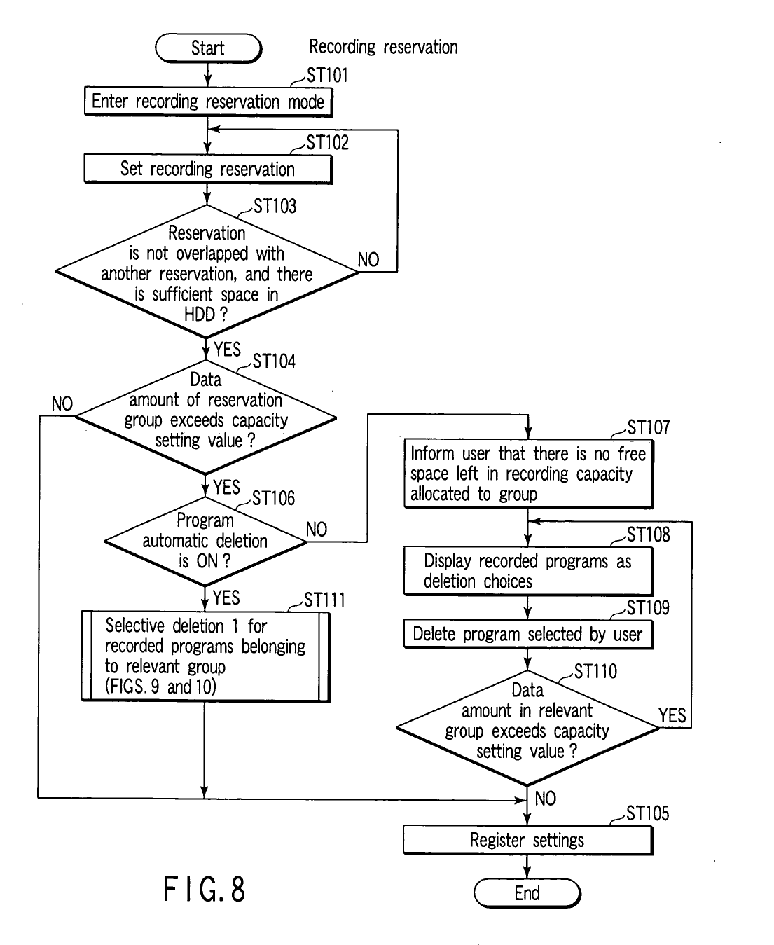

FIG. 8 is a flowchart showing an operation at the recording reservation time. Here, it is assumed that a program to be broadcasted is recorded onto the HDD 104d.

When receiving a recording reservation instruction from a user through the user input section 110, the MPU 105 enters a recording reservation mode as shown in ST (step) 101. For example, the MPU 105 allows the decoder 106 to output a video signal representing the reservation information setting window to the AV output terminal 107. As a result, the reservation information setting window as shown in FIG. 7 is displayed on the monitor screen of a television set connected to the recording/reproduction apparatus 1.

The user sets the reservation information items while checking the reservation information setting window displayed on the monitor screen, and the MPU 105 displays user settings on the reservation information setting window (ST102).

The MPU 105 refers to the set items including the channel number 11, recording start time 12, recording end time 13 and determines whether the time zone in which the program that has been reserved in this time will be broadcasted overlaps the time zone in which the programs that have already been reserved will be broadcasted. The MPU 105 also determines whether there is enough space to record the program that has been reserved in this time in the HDD 104d (ST103). If the overlap is found or there is insufficient space in the HDD 104d (No in ST103), the MPU 105 informs the user accordingly through, for example, the reservation information setting window and prompts the user to change the set reservation information or delete some recorded program (or programs), and the flow returns to ST102.

When the overlap is not found and there is sufficient space in the HDD 104d (Yes in ST103), the MPU 105 then determines whether the data amount of all the programs belonging to the relevant group exceeds the capacity setting value 22 registered in the group information table 20 (ST104). When determining that the data amount of all the programs belonging to the relevant group does not exceed the capacity setting value 22 (No in ST104), the MPU 105 stores (registers) the set reservation information in the memory 111 (ST105).

When the data amount in the relevant group exceeds the capacity setting value 22 (Yes in ST104), the MPU 105 refers to the automatic deletion 24 of the group information table 20 and determines whether the automatic deletion 24 is ON (ST106). When the automatic deletion 24 is OFF (No in ST106), the MPU 105 informs the user that there is no free space left in the recording capacity allocated to the relevant group (ST107) and selects deletion choices from the recorded programs belonging to the relevant group and displays them to prompt the user to perform selection/deletion operation (ST108). When receiving the instruction of selection/deletion from the user, the MPU 105 deletes the selected program (or programs) (ST109).

The MPU 105 again determines whether the data amount of all recorded data in the relevant group exceeds the capacity setting value 22 registered in the group information table 20 (ST110). When determining that the data amount does not exceed the capacity setting value 22 (No in ST110), the MPU 105 registers the set reservation information in the memory 111 (ST105). When determining that the data amount still exceeds the capacity setting value 22 (Yes in ST110), the flow returns to ST108, and deletion choices are selected from the recorded programs and are displayed. The deletion operation in ST 109 is repeated until the data amount used in the recording of the programs belonging to the relevant group (herein after referred to as merely “data amount”) has fallen below the corresponding capacity setting value 22.

Note that, in ST104, it may be determined whether the data amount in the relevant group exceeds the capacity setting value 22 registered in the group information table 20 on the assumption that the recording-reserved program has been recorded. Thus, in ST104, the MPU 105 may determine whether the data amount of all the programs, including the program that has been reserved in ST102, belonging to the relevant group exceeds the capacity setting value 22 registered in the group information table 20.

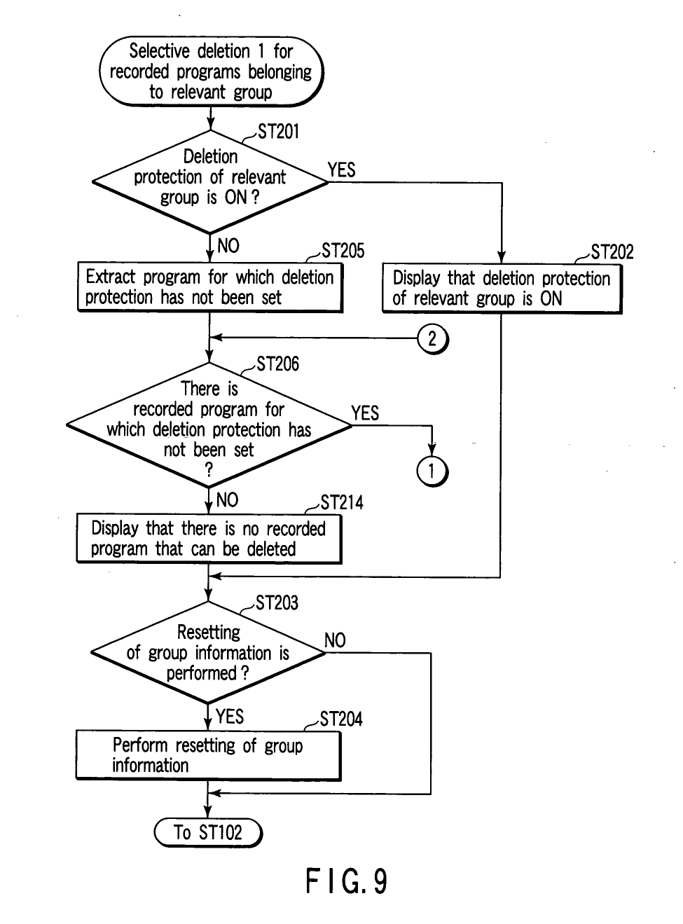

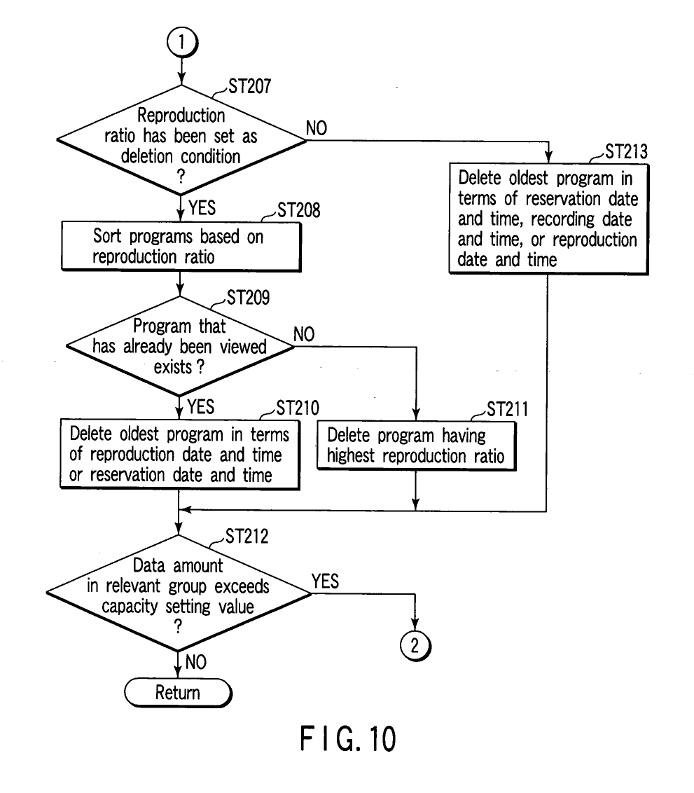

When Yes in ST106, the MPU 105 selectively deletes a recorded program belonging to the relevant group (ST111). FIGS. 9 and 10 are flowcharts showing details of selective deletion operation performed by the MPU 105 in ST111.

The MPU 105 firstly refers to the deletion protection 27 of the group information table 20 and determines whether the deletion protection of the relevant group is set (ST201). When determining that the deletion protection is ON (Yes in ST201), the MPU 105 allows a TV monitor or the like to display that the deletion protection of the relevant group is set (ST202) and inquires whether the user performs resetting of the group information (ST203). When the user selects the resetting of the group information (Yes in ST 203), the MPU 105 allows the TV monitor or the like to display a setting window (not shown) of the group information and performs the resetting of the group information related to the relevant group according to the user's instruction (ST204). Thereafter, the flow returns to ST102, and the program reservation operation is resumed.

When determining that the deletion protection of the relevant group is not set (No in ST201), the MPU 105 refers to the item of deletion protection 16 of the reservation information table 10 and extracts the program for which the deletion protection has not been set from the recorded programs in the relevant group (ST205). When determining that there is no recorded program for which the deletion protection has not been set (No in ST206), the MPU 105 allows the TV monitor or the like to display that there is no recorded program that can be deleted (ST214). The processes (ST203, ST204) after ST207 is as described above.

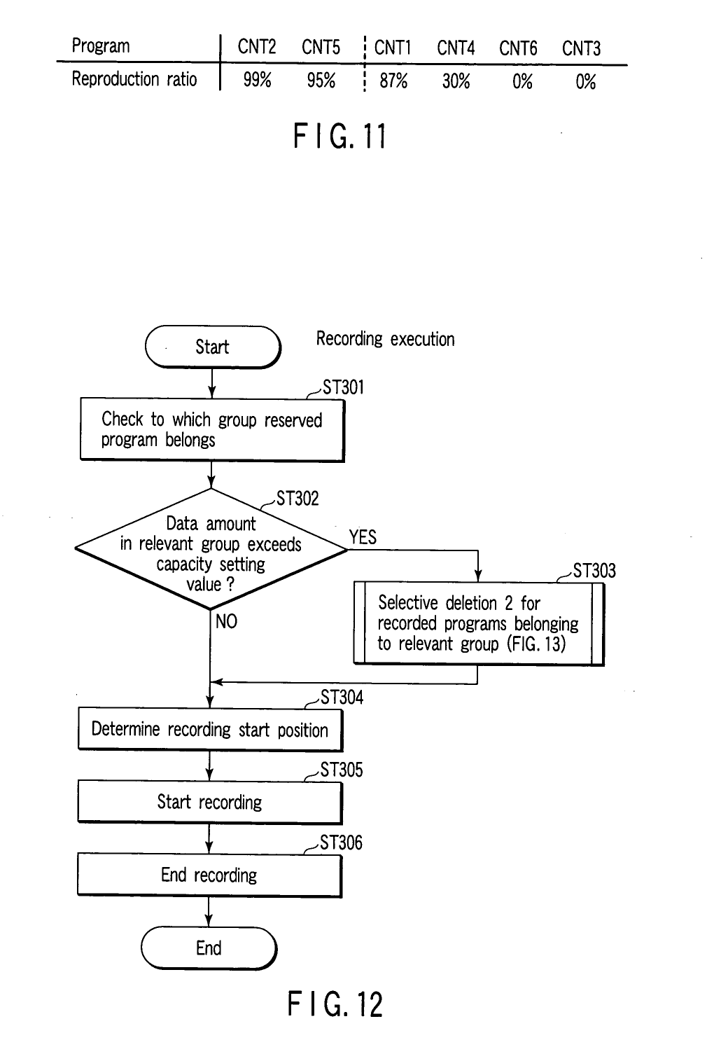

When determining that there is a recorded program for which the deletion protection has not been set (Yes in ST206), the flow shifts to ST207. In ST207, the MPU 105 determines whether the reproduction ratio (ratio of the viewed or reproduced (by the user) part to the whole) has been set as the deletion condition with reference to “deletion condition related to reproduction ratio 25a” of the group information table 20. When determining that “deletion condition related to reproduction ratio 25a” is ON (Yes in ST207), the MPU 105 arranges the recorded programs based on the reproduction ratio 40 (see FIG. 3) and sorts the programs according to the ratio (for example, 90%) set in “ratio setting value 25b” (ST208). FIG. 11 is a view showing an example of a result obtained by sorting the programs. In the case of FIG. 11, recorded programs CNT1 to CNT5 are sorted to make it easy to understand that programs CNT2 and CNT5 are the programs having a reproduction ratio of 90% or more, and programs CNT1, CNT4, CNT6, and CNT3 are the programs having the ratio of less than 90%.

The MPU 105 regards the recorded programs having a ratio equal to or higher than the ratio set in the ratio setting value 25b of the group information table 20 as a viewed program and deletes the oldest program in terms of its reproduction date and time or reservation date and time from the viewed programs with reference to the “selection result of the reproduction date and time/reservation date and time 26” (ST209, ST210). When determining that there is no viewed program (No in ST209), the MPU 105 deletes the program having the highest reproduction ratio (ST211). When the user does not set the reproduction ratio as the deletion condition (No in ST207), the MPU 105 deletes the oldest program in terms of its recording date and time or reproduction date and time (ST213).

After deleting a recorded program in ST210, ST211, or ST213, the MPU 105 determines whether the data amount in the relevant group exceeds the capacity setting value 22 registered in the group information table 20 (ST212). When determining that the data amount does not exceed the capacity setting value 22 (No in ST212), the flow shifts to ST105 of FIG. 8. When determining that the data amount still exceeds the capacity setting value 22 (Yes in ST212), the flow returns to ST206 of FIG. 9. In this manner, the deletion operation of the recorded program is repeated until the data amount in the relevant group has fallen below to the corresponding capacity setting value 22.

As described above, it is possible to the problem of running out of free space in a recording medium such as an HDD or the like from occurring by imposing some recording restrictions (capacity setting value, etc.) on each group including programs.

A second embodiment of the present invention will next be described. In the second embodiment, the deletion operation of the recorded program belonging to the group whose data amount has exceeded the capacity setting value is performed not at the recording reservation time, but at the recording execution time. FIG. 12 is a flowchart showing an operation at the time when a reserved recording is performed.

When receiving a recording start instruction from the timer microcomputer 109 immediately before the program that has been reserved by the user is broadcasted, the MPU 105 refers to the reservation information table 10 to check the group that includes the reserved program (ST 301) and determines whether the data amount in the relevant group exceeds the capacity setting value 22 registered in the group information table 20 (ST302). When determining that the data amount in the relevant group does not exceed the capacity setting value 22 (No in ST 302), the MPU 105 determines a recording start position (ST304) and starts the recording of the program from the determined start position when the reservation time has come (ST305). When recording end time has come, the MPU 105 receives a recording end instruction from the timer microcomputer 109 and ends the recording of the recording-reserved program (ST306).

When determining that the data amount in the relevant group exceeds the corresponding capacity setting value 22 (Yes in ST302), the MPU 105 selectively deletes a program from the recorded programs belonging to the relevant group (ST303).

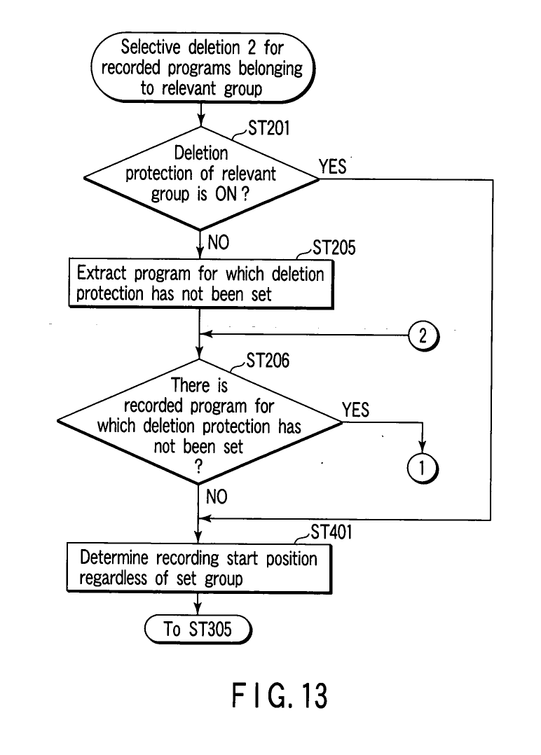

FIG. 13 is a flowchart showing a selective deletion 2 performed at the reserved recording execution time. The flowchart of FIG. 13 is substantially the same as that in the first embodiment of FIG. 9. A difference between the two is that ST202 to ST204 and ST 207 in FIG. 9 are replaced by ST401 in FIG. 13. That is, when there is no recorded program that can be deleted within the deletion protection condition, the MPU 105 ignores the set group so as to determine a recording start position of the reserved program (ST401) and performs recording of the recording-reserved program (ST305, ST306). At this time, the MPU 105 allows the display section 108 or LED (not shown) provided on the front panel of the recording/reproduction apparatus 1 to display that error has occurred. Note that, even in this case, the recording of the recording-reserved program onto the HDD 104d is performed.

According to the second embodiment, the selective deletion for recorded programs is performed at the program recording time, reducing the number of user operations needed at the reservation time.

A third embodiment of the present invention will next be described.

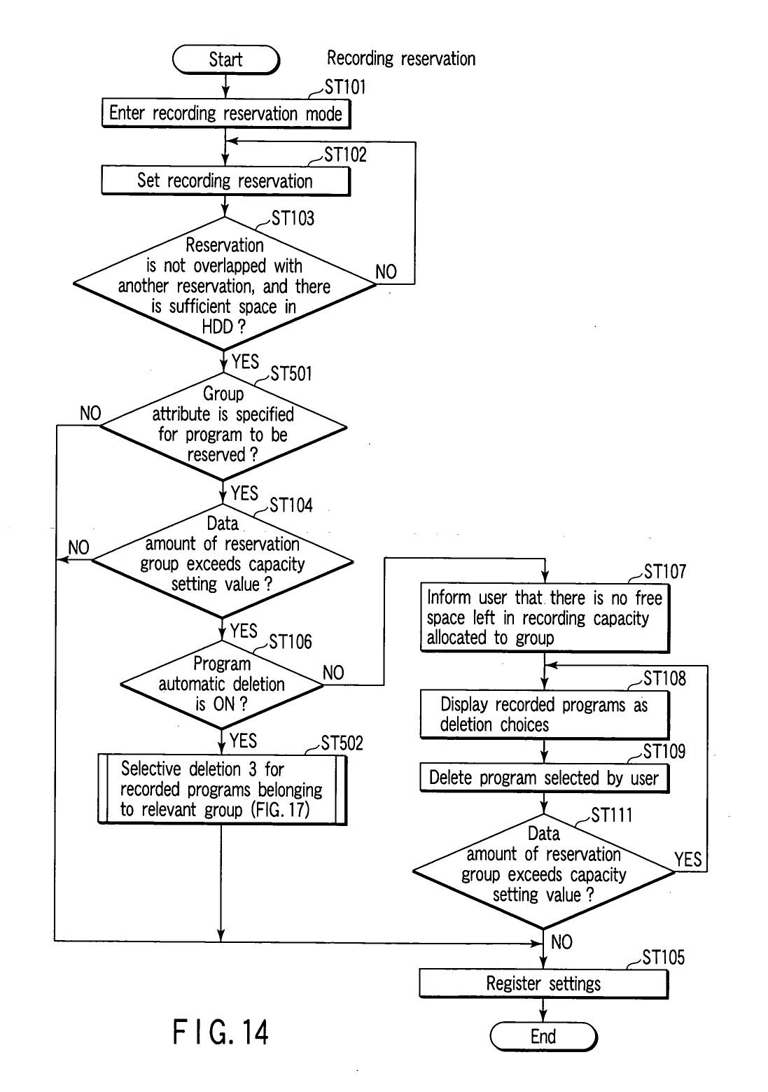

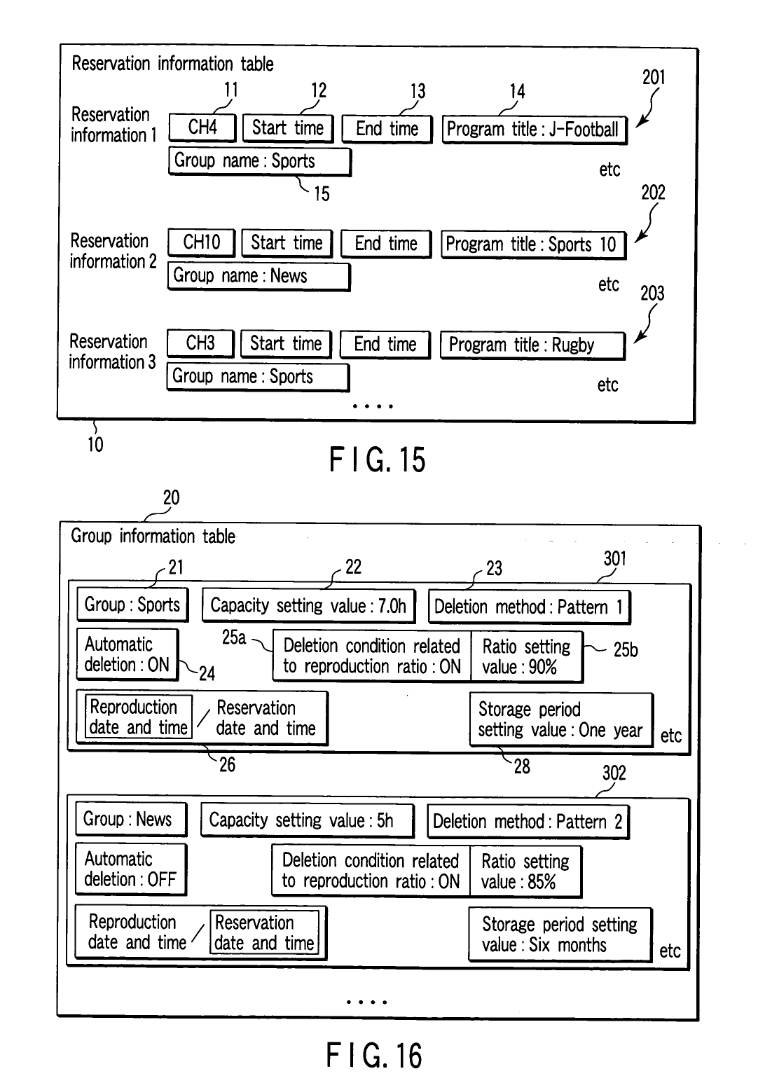

A flow of an operation, a reservation information table, and a group information table according to a third embodiment are shown in FIGS. 14, 15, and 16, respectively. In the third embodiment, the deletion protection 16 for preventing a recorded program from being deleted and deletion protection 26 for preventing all recorded programs in a group from being deleted are not provided as shown in FIGS. 15 and 16. When the total data amount of recorded programs belonging to the group specified by the user exceeds the capacity setting value 22, any of the recorded programs belonging to the relevant group is deleted.

The flowchart of FIG. 14 is substantially the same as that of FIG. 8 according to the first embodiment, but differs from it in the point that ST501 is newly provided and ST502 is provided in place of ST112. That is, when a group attribute is not specified for the program to be reserved as in the ST501 (No), the relevant program does not become a target of the selective deletion operation as performed in ST502 or one of the deletion choices as used in ST108 after being stored in the HDD 104d. Further, when determining that the automatic deletion 24 is set (ON) in ST106 (Yes), the MPU 105 performs a selective deletion 3 for the recorded programs belonging to the relevant group in ST502.

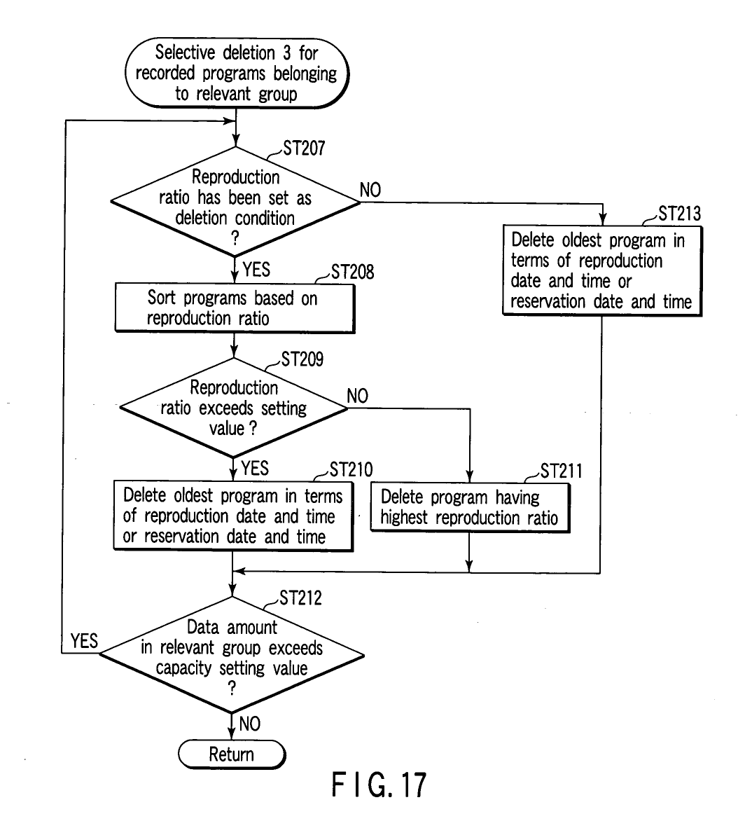

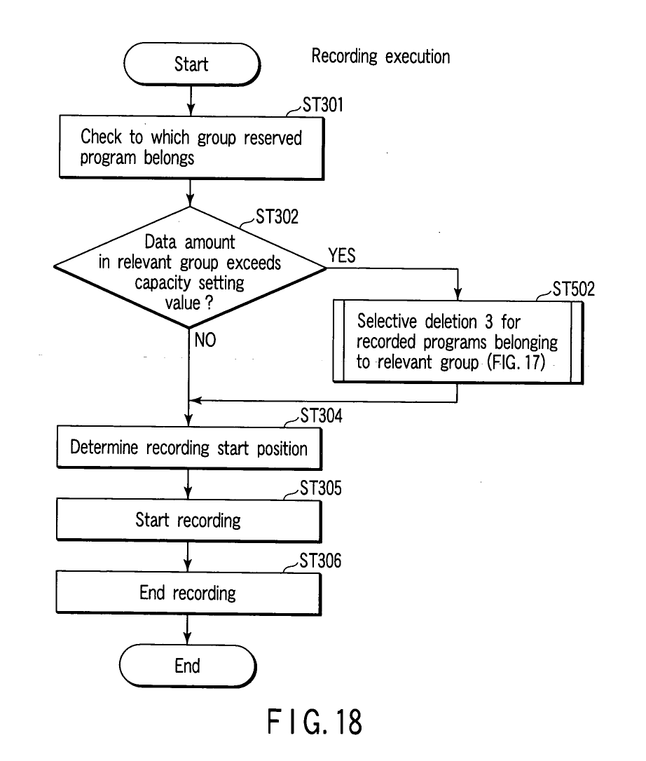

FIG. 17 is a flowchart showing the selective deletion 3 for the recorded programs belonging to the relevant group performed in ST502. The flowchart of FIG. 17 is substantially the same as that of FIG. 10, but differs from it in the destination of ST212. That is, when the data amount of all the recorded programs belonging to the relevant group exceeds the corresponding capacity setting value 22 (Yes in ST212), the flow shifts to ST207. As a result, any of the recorded programs is deleted in ST210, ST211 or ST213.

As described above, the deletion protections 16 and 26 are not provided in the third embodiment, which increases operability of the recording/reproduction apparatus.

A fourth embodiment of the present invention will next be described.

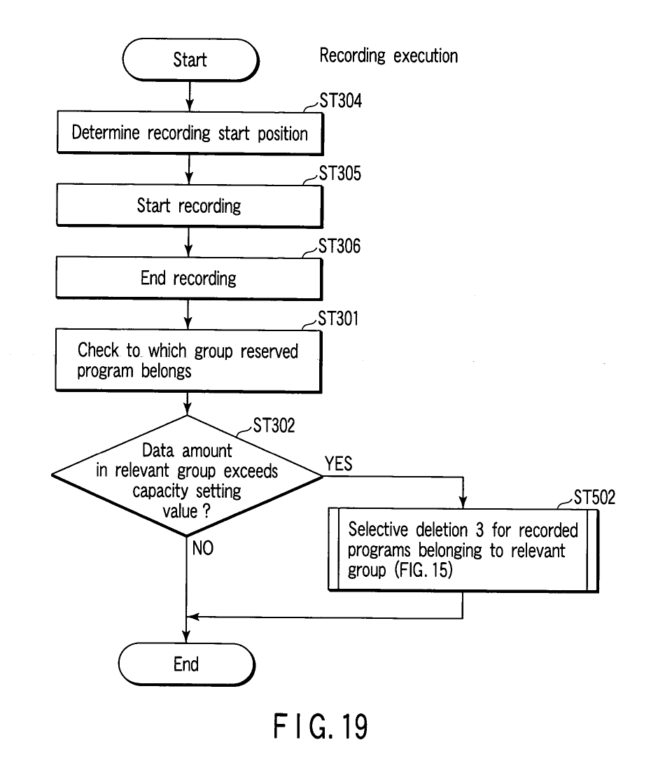

FIG. 18 is a flowchart showing an operation according to the fourth embodiment. In the fourth embodiment, the selective deletion 3 for the recorded programs belonging to the relevant group in ST502 is performed at the recording execution time. Further, in the fourth embodiment, the deletion protection 16 for preventing a recorded program from being deleted, deletion protection 26 for preventing all recorded programs in a group from being deleted, and automatic deletion 24 are not provided. The flowchart of FIG. 18 is the same as that of FIG. 12 except the point that ST502 is provided in place of ST303. Therefore, detailed description will be omitted here. According to the fourth embodiment, the selective deletion for recorded programs is performed at the program recording time, the number of user operations needed at the recording reservation time is reduced.

FIG. 19 is a flowchart showing a modification of the fourth embodiment. The flowchart of FIG. 19 is the same as that of FIG. 18 according to the fourth embodiment except that the selective deletion 3 for the recorded programs belonging to the relevant group in ST502 is performed after completion of the reserved recording. Therefore, detailed description will be omitted here. As shown in the flowchart of FIG. 19, it is possible to perform the selective deletion for the recorded programs belonging to the relevant group even after completion of the reserved recording. Therefore, flexibility in the apparatus design can be increased.

A fifth embodiment of the present invention will next be described below. In the fifth embodiment, a program that has been stored longer than the period specified by the storage period setting value 28 is deleted based on an instruction from the user.

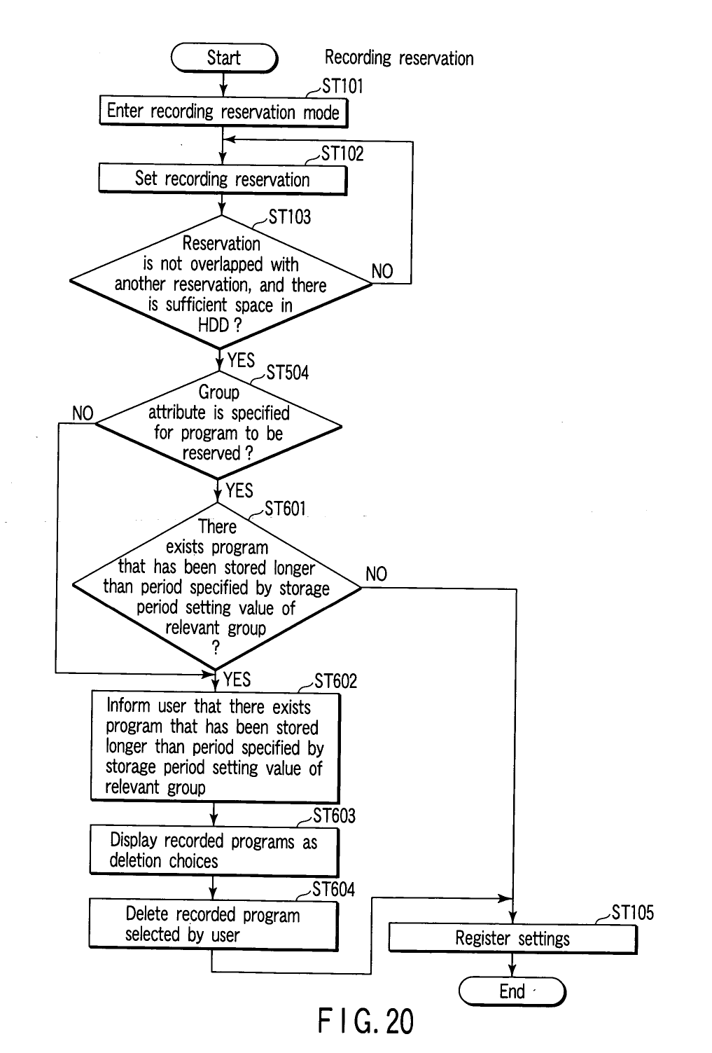

FIG. 20 is a flowchart showing an operation according to the fifth embodiment. ST101 to ST103, ST504 and ST105 are the same as those in the flowchart of FIG. 14. ST601 to ST604 constitute the fifth embodiment.

When there is a recorded program that has been stored longer than the period specified by the storage period setting value 28 at the program reservation time in the group to which the program to be reserved belongs to (Yes in ST601), the MPU 105 allows the TV monitor or the like to inform the user that there is a recorded program that has been stored longer than the period specified by the storage period setting value (ST602). The MPU 105 also allows the TV monitor or the like to display the programs that have been stored longer than the period specified by the storage period setting value as deletion choices (ST603). The MPU 105 deletes the program that the user has selected from the displayed deletion choices (ST604). Note that programs that have not been selected by the user from the deletion choices may be unlinked from a group attribute. As a result, the unlinked program is not allowed to be displayed as one of the deletion choices.

As described above, according to the fifth embodiment, the recorded program that has been stored longer than the period specified by the storage period setting value 28 can be deleted based on the user's instruction. As a result, a free space in the HDD 104d can be safely increased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A recording/reproduction apparatus comprising:
a storage unit which stores reservation information including a channel number, a recording start time, a recording end time, and an attribute of each recording-reserved program;
another storage unit which stores attribute information including a total capacity setting value related to each attribute;
a record unit which records a recording-reserved program together with the attribute of the program based on the reservation information; and
a deletion unit which selectively deletes a program from recorded programs which have the same attribute and have been recorded by the record unit, when the total data amount of the recorded programs having the same attribute exceeds the corresponding total capacity setting value.

2. The recording/reproduction apparatus according to claim 1, wherein
the deletion unit deletes a recorded program which has already been reproduced among the recorded programs having the same attribute, whose total data amount exceeds the corresponding total capacity setting value.

3. The recording/reproduction apparatus according to claim 2, wherein
the deletion unit regards a recorded program having a reproduction ratio higher than a predetermined value as the program which has already been reproduced among the recorded programs having the same attribute, whose total data amount exceeds the corresponding total capacity setting value.

4. The recording/reproduction apparatus according to claim 2, wherein
the deletion unit deletes the oldest recorded program in terms of reproduction date and time among the programs which have already been reproduced.

5. The recording/reproduction apparatus according to claim 2, wherein
the deletion unit deletes a recorded program having the highest reproduction ratio among the programs which have already been reproduced, the reproduction ratio being a ratio of reproduced part to the whole program.

6. The recording/reproduction apparatus according to claim 1, wherein
the deletion unit extracts, for presentation, deletion choices from the recorded programs having the same attribute, whose total data amount exceeds the corresponding total capacity setting value and deletes a recorded program selected by a user from the presented deletion choices.

7. The recording/reproduction apparatus according to claim 1, wherein
the attribute information further includes a storage period setting value for each attribute, and
when a storage period of a recorded program which has been recorded by the record unit exceeds the storage period setting value stored as attribute information of the program, the deletion unit deletes the recorded program.

8. A video recording/reproduction apparatus comprising:
a storage unit which stores reservation information including a channel number, a recording start time, a recording end time, and an attribute of each recording-reserved program;
another storage unit which stores attribute information including a storage period setting value related to each attribute;
a record unit which records a recording-reserved program together with the attribute based on the reservation information; and
a deletion unit which presents, as one of deletion choices, a recorded program which has been stored longer than the period specified by the storage period setting value stored as the attribute information and deletes the recorded program selected by a user from the deletion choices.

9. A recording/reproduction method comprising:
storing reservation information including a channel number, a recording start time, a recording end time, and an attribute related to each recording-reserved program;
storing attribute information including a total capacity setting value related to each attribute;
recording a recording-reserved program using a record unit together with the attribute based on the reservation information; and
selectively deleting a program from the recorded programs which have the same attribute and have been recorded by the record unit, when the total data amount of the recorded programs having the same attribute exceeds the corresponding total capacity setting value.

10. The method according to claim 9, wherein
in the deleting the program, a recorded program which has already been reproduced is deleted from the recorded programs having the same attribute, whose total data amount exceeds the corresponding total capacity setting value.

11. The method according to claim 10, wherein
the deleting the program includes regarding a recorded program having a reproduction ratio higher than a predetermined value as the program which has already been reproduced among the recorded programs having the same attribute, whose total data amount exceeds the corresponding total capacity setting value, the reproduction ratio being a ratio of reproduced part to the whole program.

12. The method according to claim 9, wherein
in the deleting the program, the oldest recorded program in terms of reproduction date and time among the programs which have already been reproduced is deleted.

13. The method according to claim 9, wherein
in the deleting the program, a recorded program having the highest reproduction ratio among the programs which have already been reproduced is deleted, the reproduction ratio being a ratio of reproduced part to the whole program.

14. The method according to claim 9, wherein
in the deleting the program, deletion choices for presentation are extracted from the recorded programs having the same attribute, whose total data amount exceeds the corresponding total capacity setting value and a recorded program selected by a user is deleted from the presented deletion choices.

15. The method according to claim 9, wherein
the attribute information further includes a storage period setting value for each attribute, and in the deleting the program, when a storage period of a recorded program which has been recorded by the record unit exceeds the storage period setting value stored as attribute information of the program, the recorded program is deleted.
